(19) United States
(12) Patent Application Publication
(10) Pub. No.: US 2006/0066555 A1
(43) Pub. Date: Mar. 30, 2006

(54) Active display device and driving method thereof

(75) Inventor: Keisuke Miyagawa, Zama (JP)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Semiconductor Energy Laboratory Co., Ltd.

(21) Appl. No.: 11/229,465

(22) Filed: Sep. 16, 2005

(30) Foreign Application Priority Data
Sep. 27, 2004 (JP) 2004-280075

(51) Int. Cl. G09G 3/36

(52) U.S. Cl. 345/100

(57) ABSTRACT

When adopting a time division gray scale, a pseudo contour occurs. The invention provides a new driver circuit and driving method of an active display device, which can reduce the occurrence of a pseudo contour by using an interlace method. The invention provides an active display device adopting an interlace method, where pixels of odd-numbered rows and odd-numbered columns and pixels of even-numbered rows and even-numbered columns are displayed during an odd-numbered frame period, and pixels of odd-numbered rows and even-numbered columns and pixels of even-numbered rows and odd-numbered columns are displayed during an even-numbered frame period. As a result, the occurrence of a pseudo contour can be reduced without increasing the frame frequency.

### BACKGROUND OF THE INVENTION

1. Field of the Invention

The present invention relates to a method of driving an active display device while preventing a pseudo contour, and to an active display device having a driver circuit for achieving the same.

2. Description of the Related Art

A driving method called a time division gray scale is known as a digital gray scale driving method that is one of the display methods of an active display device. According to the time division gray scale, one frame period is divided into a plurality of subframe periods, during each of which light emission/non-light emission of an element is controlled to perform a gray scale display.

In the case of performing the time division gray scale, however, a pseudo contour occurs in some cases, which degrades image quality. The pseudo contour is a phenomenon where an unnecessary bright line or dark line is seen when a halftone image is displayed.

In order to prevent the pseudo contour, a plasma display using an interlace method is suggested, where the relative brightness of the final subfield of the odd-numbered (even-numbered) fields is determined by the total number of sustains of the final subfield of the odd-numbered (even-numbered) fields and one or more subfields of the even-numbered (odd-numbered) fields (see Patent Document 1).

Meanwhile, in order to prevent a flicker, suggested is a method where one field is divided into eight subfields in a plasma display, and every other scan electrode is addressed by interlace scanning in the four lower bits (see Patent Document 2).

[Patent Document 1] Japanese Patent Laid-Open No. 2000-148084

[Patent Document 2] Japanese Patent Laid-Open No. H 11-24628

The plasma display disclosed in Patent Document 1 and Patent Document 2 is a passive display device, which is driven in a different manner than an active display device having a plurality of semiconductor elements in a pixel portion. In addition, a driver circuit of the plasma display adopting the interlace method is not described in detail in Patent Document 1 and Patent Document 2.

### SUMMARY OF THE INVENTION

In view of the foregoing, the invention provides a new driving method using the interlace method to prevent a pseudo contour in an active display device, particularly in an active display device having a light emitting element. Further, the invention provides a new driver circuit of an active display device using the interlace method.

In view of the aforementioned problem, according to the invention, images are displayed using the interlace method in an active display device, particularly in an active display device having a light emitting element. More preferably, according to the invention, a plurality of pixels are divided into a display area and a non-display area that are arranged in a lattice pattern. In order that the display area and the non-display area are arranged in a lattice pattern, a switching element is provided in a driver circuit.

According to one specific mode of the invention, a driving method of an active display device having a plurality of pixels arranged in matrix includes the steps of displaying an image on pixels belonging to both odd-numbered rows and odd-numbered columns and pixels belonging to both even-numbered rows and even-numbered columns during an odd-numbered frame period, and displaying an image on pixels belonging to both the odd-numbered rows and the even-numbered columns and pixels belonging to both the even-numbered rows and the odd-numbered columns during an even-numbered frame period.

According to another mode of the invention, an active display device has a plurality of pixels at intersections of a plurality of signal lines and a plurality of scan lines. A circuit for controlling a semiconductor element connected to the signal lines has a shift register and a latch circuit. The shift register has shift register units, and the latch circuit has latch units and a wiring inputted with an inversion signal for controlling the selection of the latch units. Adjacent latch units are connected between adjacent shift register units, and one of the adjacent latch units is selected by a signal from the shift register units and the inversion signal.

According to another mode of the invention, an active display device has a plurality of pixels at intersections of a plurality of signal lines and a plurality of scan lines. A circuit for controlling a semiconductor element connected to the signal lines has a shift register and a latch circuit. The shift register has shift register units, and the latch circuit has latch units, a wiring inputted with an inversion signal for controlling the selection of the latch units, and a switching element switched by the inversion signal. Adjacent latch units are connected between adjacent shift register units, and one of the adjacent latch units is selected by the switching element.

According to another mode of the invention, an active display device has a plurality of pixels at intersections of a plurality of signal lines and a plurality of scan lines. A circuit for controlling a semiconductor element connected to the scan lines has a wiring inputted with a selection signal, an AND circuit, a shift register, and a level shifter. The AND circuit is inputted with a signal from the shift register and the selection signal and connected so as to output a signal to the level shifter.

According to another mode of the invention, an active display device has a plurality of pixels at intersections of a plurality of signal lines and a plurality of scan lines. A circuit for controlling a semiconductor element connected to the signal lines has a shift register and a latch circuit. The shift register has shift register units, and the latch circuit has latch units, a wiring inputted with an inversion signal for controlling the selection of the latch units, and a switching element switched by the inversion signal. The latch units are connected between adjacent shift register units.

According to the invention, a pseudo contour can be prevented in an active display device that performs a gray scale display by the time division gray scale. In particular, the invention is effective since a pseudo contour can be prevented without increasing the frame frequency.

In addition, according to the invention, interlace defect where a striped pattern occurs can be prevented in an active display device that performs a gray scale display by the time division gray scale.

### BRIEF DESCRIPTION OF THE DRAWINGS

FIGS. 1A and 1B are schematic diagrams showing a driving method of the invention.

FIGS. 2A and 2B are timing charts using a driving method of the invention.

FIG. 3 is a diagram showing a scan line driver circuit of the invention.

FIG. 4 is a diagram showing a signal line driver circuit of the invention.

FIGS. 5A and 5B are schematic diagrams showing a driving method of the invention.

FIGS. 6A and 6B are timing charts using a driving method of the invention.

FIG. 7 is a diagram showing a scan line driver circuit of the invention.

FIG. 8 is a diagram showing a signal line driver circuit of the invention.

FIG. 9 is a cross sectional view showing a panel configuration of the invention.

FIGS. 10A to 10C are cross sectional views showing a light emitting element provided in a pixel portion of the invention.

FIGS. 11A to 11C are cross sectional views showing a light emitting element provided in a pixel portion of the invention.

FIGS. 12A to 12C are diagrams each showing a pixel circuit that can be applied to a pixel portion of the invention.

FIGS. 13A to 13F are views each showing an electronic appliance of the invention.

### DETAILED DESCRIPTION OF THE INVENTION

Although the invention will be fully described by way of Embodiment Modes with reference to the accompanying drawings, it is to be understood that various changes and modifications will be apparent to those skilled in the art. Therefore, unless such changes and modifications depart from the scope of the invention, they should be construed as being included therein. Note that the same part or parts having the same function are denoted by the same reference numeral in all the drawings for describing Embodiment Modes, and the description thereof is omitted.

### Embodiment Mode 1

Described in this embodiment mode are a method of driving an active display device performing a gray scale display by the time division gray scale using an interlace method, and a driver circuit for achieving the driving method.

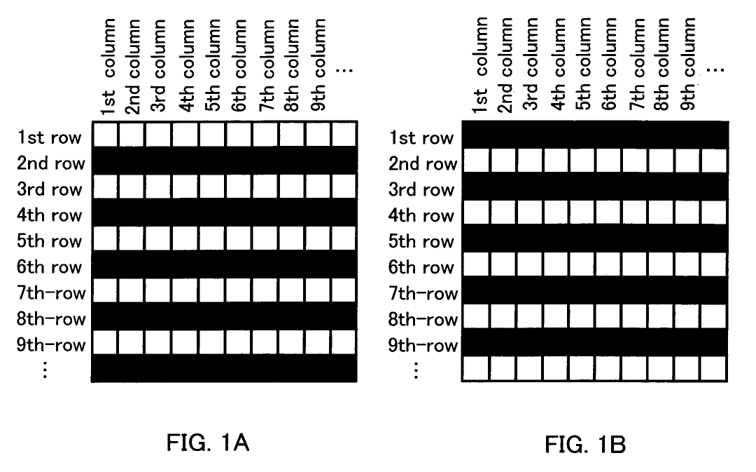

FIGS. 1A and 1B are schematic diagrams showing a pixel portion of an active display device, where semiconductor elements are arranged in matrix. White images are displayed in a display pixel while black images are displayed in a non-display pixel. In such a pixel portion, an image is displayed on only pixels of odd-numbered rows during a first frame period (see FIG. 1A), and an image is displayed on only pixels of even-numbered rows during a second frame period (see FIG. 1B). That is to say, a display area and a non-display area are arranged in a line in the pixel portion. Each of the first frame period and the second frame period may correspond to one subframe period in the time division gray scale.

In this embodiment mode, the first frame period is referred to as the odd-numbered frame period whereas the second frame period is referred to as the even-numbered frame period.

In the pixel portion of the invention, an image may be displayed on pixels of the even-numbered rows only during the odd-numbered frame period, and an image may be displayed on pixels of the odd-numbered rows only during the even-numbered frame period.

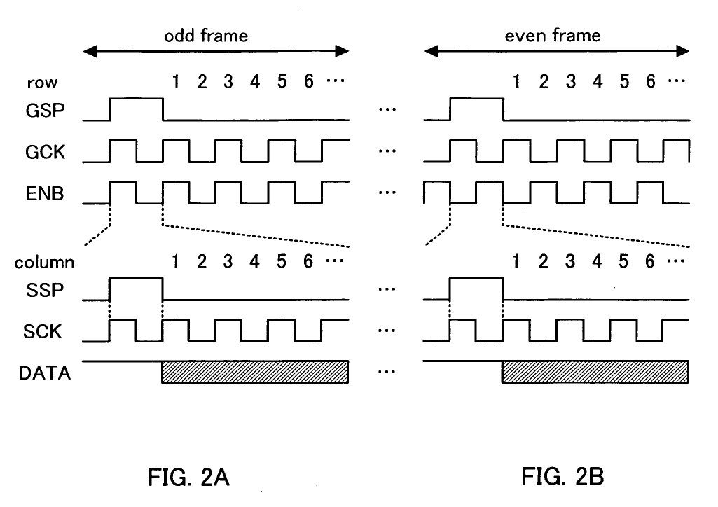

FIGS. 2A and 2B show timing charts for performing such a display. FIG. 2A shows a scan line start pulse (GSP), a scan line clock signal (GCK), and a selection signal (ENB) for selecting a signal line in the row direction (hereinafter referred to as a scan line) during the odd-numbered frame period, as well as a start pulse (SSP) and a start clock signal (SCK) for selecting a signal line in the column direction (hereinafter referred to as a signal line). FIG. 2A also shows a timing of a video signal (DATA) written based on these signals.

FIG. 2B shows a timing chart during the odd-numbered frame period. The timing shown in FIG. 2B is the same as that of FIG. 2A, except in that High and Low levels of the ENB signal are inverted.

During the odd-numbered frame period, pixels of the odd-numbered rows in the pixel portion are selected only when the ENB signal is High. Meanwhile, during the odd-numbered frame period, pixels of the even-numbered rows in the pixel portion are selected only when the ENB signal is High. In other words, in the pixel portion of the invention, the scan line is selected only when the ENB signal is High.

The video signal (DATA) is inputted to a selected pixel after the SSP signal is inputted. The video signal (DATA) may be taken in one gate clock period. Note that the selected pixel means a pixel having a semiconductor element connected to a selected scan line.

Explanation is made on a circuit (hereinafter referred to as a scan line driver circuit) for controlling a scan line, that is, for controlling on/off of a semiconductor element connected to the scan line in order to perform such a display. Explanation is also made on a circuit (hereinafter referred to as a signal line driver circuit) for controlling a signal line, that is, for controlling on/off of a semiconductor element connected to the signal line in order to perform such a display.

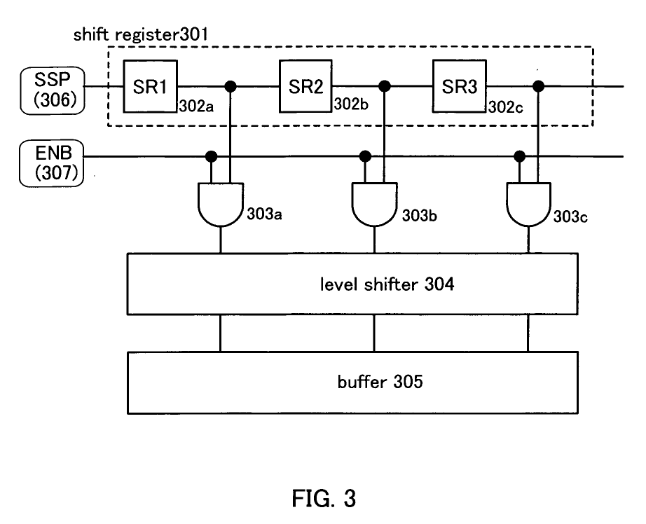

FIG. 3 shows a scan line driver circuit having a shift register 301, a level shifter 304, and a buffer 305. The shift register 301 is inputted with an SSP signal (306) and includes a plurality of shift register units 302a to 302c. AND circuits 303a to 303c are provided between the shift register 301 and the level shifter 304. An input terminal of each of the AND circuits is connected between adjacent shift register units and to a signal line inputted with an ENB signal (307). An output terminal of each of the AND circuits is connected to the level shifter 304. According to the invention, in the scan line driver circuit shown in FIG. 3, the output is controlled by the shift register 301 and the ENB signal (307) so that a selected scan line is different in each frame period.

Note that in the invention, the arrangement of the AND circuits is not limited to that shown in FIG. 3. The AND circuits may be provided anywhere as long as they can be inputted with the ENB signal and a signal from the shift register and can output a signal to the level shifter.

That is to say, the scan line driver circuit of the invention is characterized by having the signal line inputted with the ENB signal and the AND circuits that output a signal depending on the ENB signal and a signal from the shift register. Note that the output of the AND circuits is controlled by the ENB signal in the invention, and a logic circuit having a similar function may be used instead. For example, a NAND circuit may be used as well.

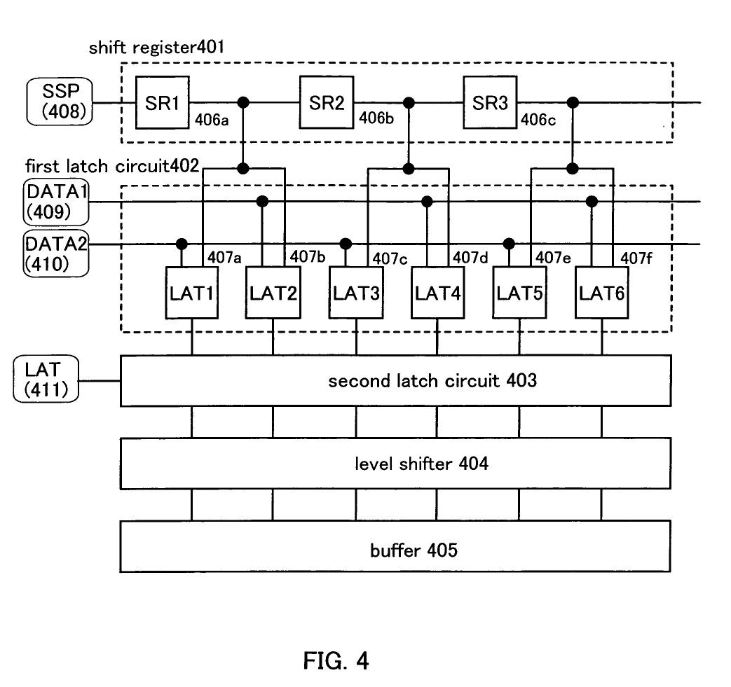

Next, a signal line driver circuit is described with reference to FIG. 4. A signal line driver circuit used in the invention has a shift register 401, a first latch circuit 402, a second latch circuit 403, a level shifter 404, and a buffer 405. The shift register 401 is inputted with an SSP signal (408) and includes a plurality of shift register units 406a to 406c. The first latch circuit 402 includes a plurality of latch units 407a to 407f. Adjacent latch units are connected between adjacent shift register units. Each of the latch units is connected to a signal line inputted with one of a first image signal (DATA1) 409 and a second image signal (DATA2) 410. In this embodiment mode, the plurality of latch units are connected to signal lines so as to be alternately inputted with the DATA1 and the DATA2. In this manner, each of the latch units is inputted with the DATA1 and the DATA2, and outputs a signal to the second latch circuit 403.

The second latch circuit 403 is inputted with a latch signal (LAT) 411 and outputs a signal to the level shifter 404.

If the interlace method shown in FIGS. 1A and 1B is adopted, it is preferable to use the signal line driver circuit capable of sequentially selecting all signal lines in the pixel portion. Although the two signals DATA1 and DATA2 are inputted in parallel in this embodiment mode, one signal line or three or more signal lines may be provided.

According to the invention having the aforementioned configuration, the occurrence of a pseudo contour can be reduced in the active display device performing the time division gray scale.

In order to prevent a pseudo contour, it is necessary to increase the frame frequency in the prior art. In this case, a driver circuit may be overloaded with the increase in the frame frequency or the amount of information of a video signal may be increased. Accordingly, the driver circuit is overloaded, and in particular the frequency of a latch circuit is increased, leading to increase in the number of wirings for inputting a video signal. On the other hand, the driving method and the driver circuit according to the invention are effective since a pseudo contour can be prevented without increasing the frame frequency and the driver circuit is not overloaded.

By adopting the interlace method, the amount of information of a video signal can be reduced to half. As a result, the number of signal lines and scan lines can be reduced, which increases the aperture ratio.

There is concern that luminance may be reduced when adopting the interlace method. If an organic material is used for a light emitting element in the active display device of the invention, however, the luminance of the light emitting element is reduced exponentially, and thus it is not necessary to increase a supplied voltage with the reduction in the luminance. In other words, the interlace method is preferably used in the active display device that has a light emitting element containing an organic material rather than a plasma display.

In the invention, a thin film transistor can be used for the semiconductor element connected to the signal line or the scan line.

### Embodiment Mode 2

Described in this embodiment mode is an interlace method that is different from that shown in Embodiment Mode 1.

According to the driving methods disclosed in the foregoing Patent Documents 1 and 2, a striped pattern easily occurs. In view of this, this embodiment mode shows a driving method for preventing the striped pattern as well as a pseudo contour.

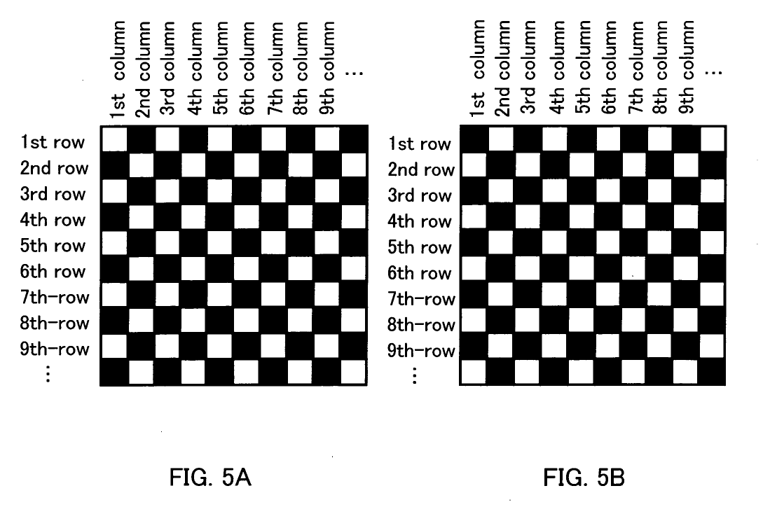

FIG. 5 shows a pixel portion of an active display device, where semiconductor elements are arranged in matrix. White images are displayed in a display pixel while black images are displayed in a non-display pixel. In such a pixel portion, an image is displayed on pixels belonging to both odd-numbered rows and odd-numbered columns and pixels belonging to both even-numbered rows and even-numbered columns only during a first frame period (see FIG. 5A), and an image is displayed on pixels belonging to both the odd-numbered rows and the even-numbered columns and pixels belonging to both the even-numbered rows and the odd-numbered columns only during a second frame period (see FIG. 5B). That is to say, in the pixel portion, a display area and a non-display area are provided in a lattice pattern.

In this embodiment mode, the first frame period is referred to as the odd-numbered frame period whereas the second frame period is referred to as the even-numbered frame period.

In the pixel portion of the invention, an image may be displayed on pixels belonging to both the odd-numbered rows and the even-numbered columns and pixels belonging to both the even-numbered rows and the odd-numbered columns only during the odd-numbered frame period, and an image may be displayed on pixels belonging to both the odd-numbered rows and the odd-numbered columns and pixels belonging to both the even-numbered rows and the even-numbered columns only during the even-numbered frame period.

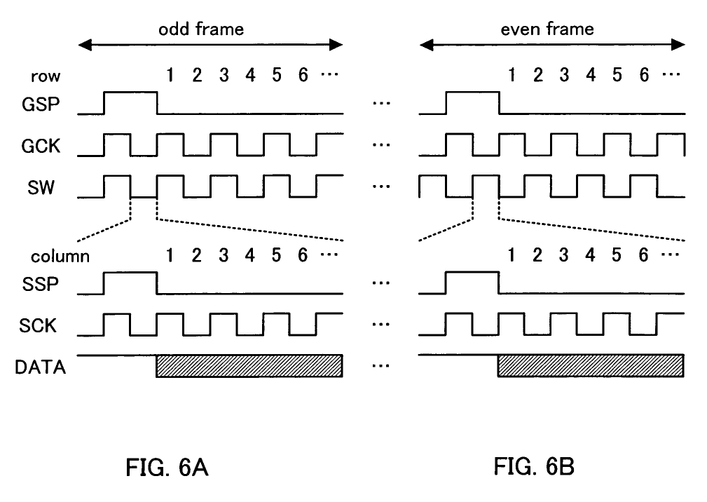

FIGS. 6A and 6B show timing charts for performing such a display. FIG. 6A shows a scan line start pulse (GSP), a scan line clock signal (GCK), and an inversion signal (SW) for selecting a scan line during the odd-numbered frame period, as well as a start pulse (SSP) and a start clock signal (SCK) for selecting a signal line. FIG. 6A also shows a timing of a video signal (DATA) written based on these signals.

FIG. 6B shows a timing chart during the even-numbered frame period. The timing shown in FIG. 6B is the same as that of FIG. 6A, except in that High and Low levels of the SW signal are inverted.

During the odd-numbered frame period, pixels of the odd-numbered columns are selected when the SW signal is High, and pixels of the even-numbered columns are selected when the SW signal is Low. Meanwhile, during the even-numbered frame period, pixels of the even-numbered columns are selected when the SW signal is High, and pixels of the odd-numbered columns are selected when the SW signal is Low.

The video signal (DATA) is inputted to a selected pixel after the SSP signal is inputted. The selected pixel means a pixel having a semiconductor element connected to a selected scan line.

Explanation is made on a scan line driver circuit and a signal line driver circuit to perform such a display.

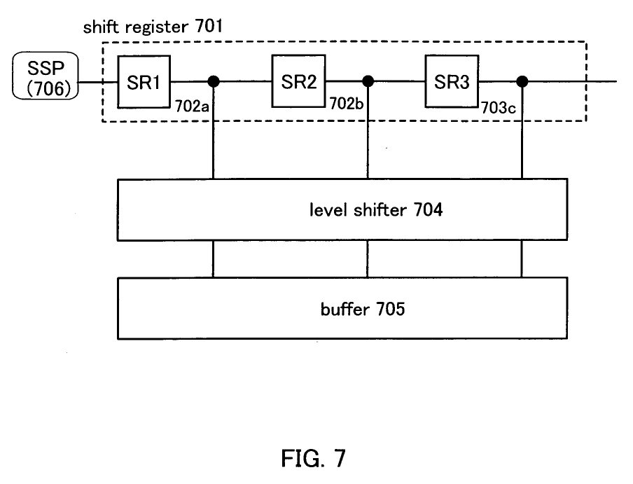

FIG. 7 shows a scan line driver circuit having a shift register 701, a level shifter 704, and a buffer 705. The shift register 701 is inputted with an SSP signal (706) and includes a plurality of shift register units 702a to 702c. The level shifter 704 is connected between adjacent shift register units.

Such a scan line driver circuit according to the invention can select all the scan lines sequentially.

In this embodiment mode, the scan line driver circuit inputted with the ENB signal as shown in FIG. 3 may be used as well.

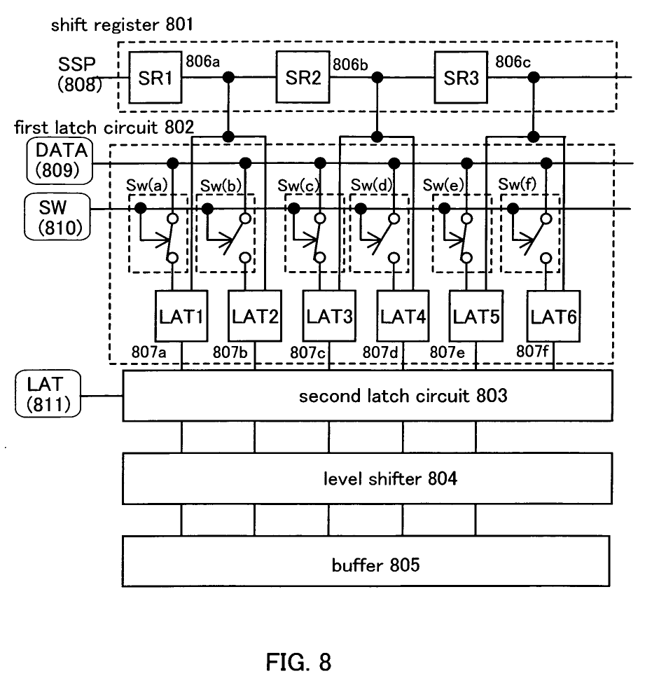

Next, a signal line driver circuit is described with reference to FIG. 8. A signal line driver circuit used in the invention has a shift register 801, a first latch circuit 802, a second latch circuit 803, a level shifter 804, and a buffer 805. The shift register 801 is inputted with an SSP signal (808) and includes a plurality of shift register units 806a to 806c. The first latch circuit 802 includes a plurality of latch units 807a to 807f and a plurality of switching elements Sw(a) to Sw(f). Adjacent latch units are connected between adjacent shift register units. The switching elements Sw(a) to Sw(f) are controlled by an SW signal (810) to select one of the adjacent latch units. As such switching elements controlled at different timings, semiconductor elements with different conductivity types may be employed. In this manner, each of the latch units is inputted with DATA and outputs a signal to the second latch circuit 803.

The second latch circuit 803 is inputted with a latch signal (LAT) 811 and outputs a signal to the level shifter 804.

In the case of adopting the interlace method shown in FIGS. 5A and 5B, a column of signal line inputted with DATA is changed in each frame period. Therefore, a column of pixels inputted with DATA is changed by the SW signal. Accordingly, the invention is not limited to the signal line driver circuit shown in FIG. 8, and other circuits may be used as long as a column of pixels inputted with DATA can be changed in each frame period.

According to the invention having the aforementioned configuration, the occurrence of a striped pattern as well as a pseudo contour can be reduced in the active display device performing the time division gray scale.

In particular, the driving method and the driver circuit according to the invention are effective since a pseudo contour can be prevented without increasing the frame frequency similarly to Embodiment Mode 1.

By adopting the interlace method, the amount of information of a video signal can be reduced to half. As a result, the number of signal lines and scan lines can be reduced, which increases the aperture ratio.

There is concern that luminance may be reduced when adopting the interlace method. If an organic material is used for a light emitting element in the active display device of the invention, however, the luminance of the light emitting element is reduced exponentially, and thus it is not necessary to increase a supplied voltage with the reduction in the luminance. In other words, the interlace method is preferably used in the active display device that has a light emitting element containing an organic material rather than a plasma display.

In the invention, a thin film transistor can be used for a semiconductor element connected to a signal line or a scan line.

### Embodiment Mode 3

Described in this embodiment mode is a configuration of a panel having the pixel portion and the driver circuit according to the invention.

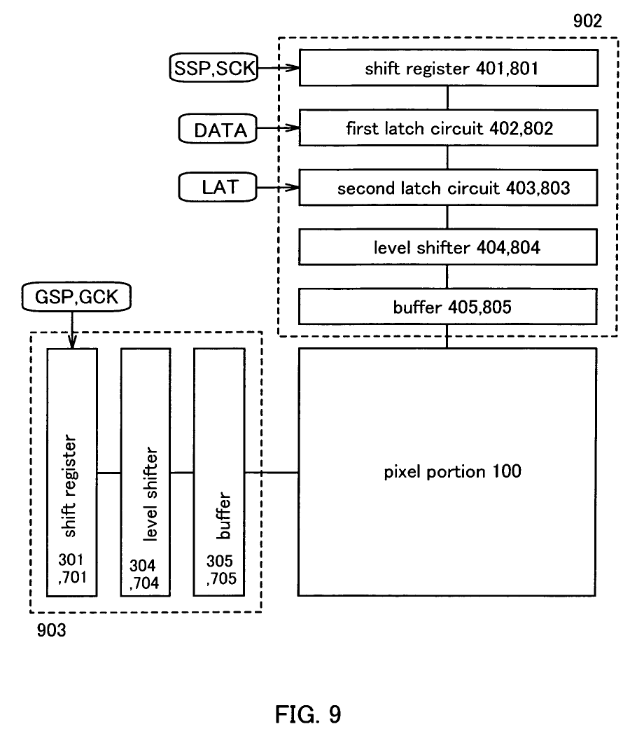

FIG. 9 shows a panel where driver circuits including a scan line driver circuit 903 and a signal line driver circuit 902 shown in the aforementioned embodiment modes are provided at the periphery of a pixel portion 100.

The scan line driver circuit 903 has a shift register, a level shifter, and a buffer. The signal line driver circuit 902 has a shift register, a first latch circuit, a second latch circuit, a level shifter, and a buffer. The pixel portion 100 includes a plurality of pixels each having a light emitting element. A cross sectional structure of the pixel is described in an embodiment mode below.

The signal line driver circuit 902, the scan line driver circuit 903, and the pixel portion 100 may be formed using semiconductor elements formed over the same substrate. For example, thin film transistors formed over a glass substrate may be used. Alternatively, the signal line driver circuit 902 and the scan line driver circuit 903 may be incorporated onto a glass substrate using an IC chip.

This embodiment mode can be implemented in combination with any of the aforementioned embodiment modes.

### Embodiment Mode 4

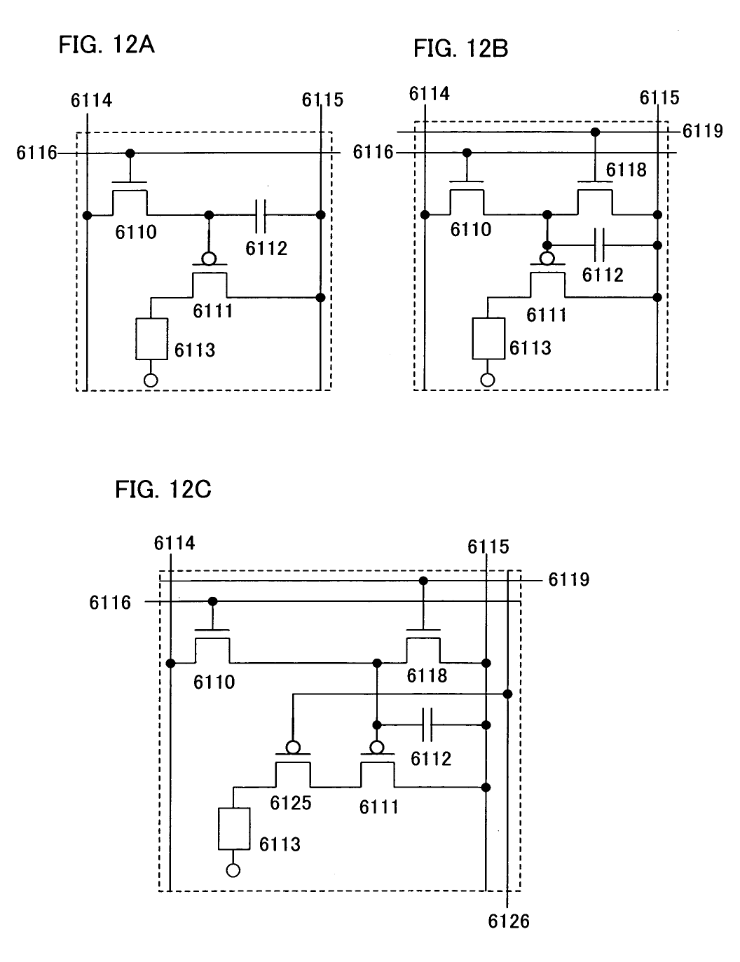

In this embodiment mode, equivalent circuit diagrams of a pixel included in an active display device are described with reference to FIGS. 12A to 12C.

FIG. 12A shows an example of an equivalent circuit diagram of a pixel, which includes a signal line 6114, a power supply line 6115, and a scan line 6116. A light emitting element 6113, transistors 6110 and 6111, and a capacitor 6112 are provided at an intersection of these lines. A video signal is inputted to the signal line 6114 from a signal line driver circuit. The transistor 6110 can control the supply of the video signal potential to a gate electrode of the transistor 6111. The transistor 6111 can control current supply to the light emitting element 6113 depending on the potential of the video signal. The capacitor 6112 can hold a gate-source voltage of the transistor 6111. Although the capacitor 6112 is shown in FIG. 12A, it is not necessarily provided if the gate capacitance of the transistor 6111 or other parasitic capacitance can be used instead.

FIG. 12B is an equivalent circuit diagram of a pixel where a transistor 6118 and a scan line 61.19 are provided in addition to the pixel shown in FIG. 12A. The transistor 6118 allows gate and source electrodes of the transistor 6111 to have the same potential, thereby current supply to the light emitting element 6113 can be forcibly stopped. Accordingly, the length of a display period can be made shorter than a period during which video signals are inputted to all the pixels.

FIG. 12C is an equivalent circuit diagram of a pixel where a transistor 6125 and a wiring 6126 are provided in addition to the pixel shown in FIG. 12B. The potential of a gate electrode of the transistor 6125 is connected to the wiring 6126 with a fixed potential. The transistor 6111 and the transistor 6125 are connected in series between the power supply line 6115 and the light emitting element 6113. Thus, in FIG. 12C, a current value supplied to the light emitting element 6113 can be controlled by the transistor 6125, and whether the current is supplied to the light emitting element 6113 can be controlled by the transistor 6111.

The configuration of the pixel circuit of the invention is not limited to those shown in this embodiment mode, and the invention can be applied to any display device performing the time division gray scale display. This embodiment mode can be implemented in combination with any of the aforementioned embodiment modes.

### Embodiment Mode 5

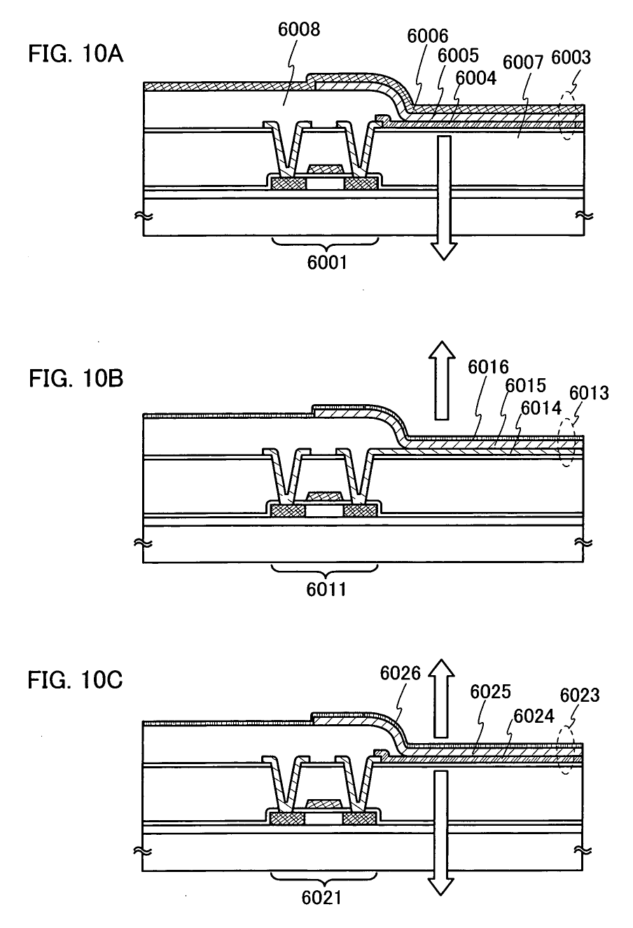

Described in this embodiment mode is a cross sectional structure of a pixel having a light emitting element. Cross sectional structures of a pixel where a P-channel thin film transistor (TFT) is used as the aforementioned transistor for controlling current supply to a light emitting element are described with reference to FIGS. 10A to 10C. Note that in the invention, one electrode of an anode and a cathode of the light emitting element, the potential of which can be controlled by a transistor is referred to as a first electrode, and the other electrode is referred to as a second electrode. FIGS. 10A to 10C show the case where the first electrode is the anode while the second electrode is the cathode, though the first electrode may be the cathode while the second electrode may be the anode.

FIG. 10A is a cross sectional view of a pixel where a TFT 6001 has P-type conductivity and light emitted from a light emitting element 6003 is extracted from a first electrode 6004 side. In FIG. 10A, the first electrode 6004 of the light emitting element 6003 is electrically connected to the TFT 6001.

The TFT 6001 is covered with an interlayer insulating film 6007, and a bank 6008 having an opening is formed over the interlayer insulating film 6007. A part of the first electrode 6004 is exposed in the opening of the bank 6008. In this opening, the first electrode 6004, an electroluminescent layer 6005, and a second electrode 6006 are stacked in this order.

The interlayer insulating film 6007 may be formed using an organic resin film, an inorganic insulating film, or an insulating film (hereinafter referred to as a siloxane based insulating film) that is formed using a siloxane based material as a starting material and includes a Si—O—Si bond. Siloxane is composed of a skeleton formed by the bond of silicon (Si) and oxygen (O), in which an organic group containing at least hydrogen (such as an alkyl group or aromatic hydrocarbon) is included as a substituent. Alternatively, a fluoro group may be used as the substituent. Further alternatively, a fluoro group and an organic group containing at least hydrogen may be used as the substituent. The interlayer insulating film 6007 may be formed of a material called a low dielectric constant material (low-k material).

The bank 6008 may be formed using an organic resin film, an inorganic insulating film, or a siloxane based insulating film. As the organic resin film, for example, acrylic, polyimide, polyamide and the like may be used, and silicon oxide, silicon nitride oxide and the like may be used as the inorganic insulating film. In particular, the first electrode 6004 and the second electrode 6006 can be prevented from being connected to each other when a photosensitive organic resin film is used for the bank 6008, and an opening is formed over the first electrode 6004 so that the side wall thereof slopes with a continuous curvature.

The first electrode 6004 is formed using a material that transmits light or formed to have a thickness to transmit light. In either case, a material suitable for the anode is used. For example, the first electrode 6004 may be formed using conductive oxide materials that transmit light, such as indium tin oxide (ITO), zinc oxide (ZnO), indium zinc oxide (IZO), and gallium doped zinc oxide (GZO). Alternatively, ITO, zinc oxide containing silicon oxide, indium tin oxide containing silicon oxide (hereinafter referred to as ITSO), or ITSO mixed with zinc oxide (ZnO) of 2 to 20 atomic % may be used for the first electrode 6004. Further, instead of using the aforementioned conductive oxide materials that transmit light, the first electrode 6004 may be formed of a single layer film containing one or more of TiN, ZrN, Ti, W, Ni, Pt, Cr, Ag, Al and the like, a stacked layer film of a titanium nitride film and a film mainly containing aluminum, or a three-layer film of a titanium nitride film, a film mainly containing aluminum, and a titanium nitride film. In the case of using a material other than the conductive oxide materials that transmit light, the first electrode 6004 is formed to have a thickness to transmit light (preferably about 5 to 30 nm).

The second electrode 6006 is formed using a material that reflects or blocks light, or formed to have a thickness to reflect or block light. In either case, a metal, an alloy, a conductive compound, and a mixture thereof, each of which has a low work function may be used. Specifically, it is possible to use an alkaline metal such as Li and Cs, an alkaline earth metal such as Mg, Ca and Sr, an alloy (Mg:Ag, Al:Li, Mg:In) or a compound (calcium fluoride such as CaF₂, calcium nitride such as Ca₃N₂) containing them, and a rare earth metal such as Yb and Er. If an electron injection layer is provided, other conductive layers such as Al may be employed as well.

The electroluminescent layer 6005 is formed of a single layer or plural layers. If the electroluminescent layer 6005 is formed of plural layers, these layers can be classified into a hole injection layer, a hole transporting layer, a light emitting layer, an electron transporting layer, an electron injection layer and the like in view of carrier transporting characteristics. If the electroluminescent layer 6005 includes any of a hole injection layer, a hole transporting layer, an electron transporting layer, and an electron injection layer as well as a light emitting layer, the hole injection layer, the hole transporting layer, the light emitting layer, the electron transporting layer, and the electron injection layer are stacked in this order from the first electrode 6004. Note that the boundaries between each layer are not necessarily clearly defined, and there is also a case where materials of the respective layers are partially mixed with each other, which blurs the boundaries. Each of the layers may be formed using an organic material or an inorganic material. As the organic material, any of a high molecular weight material, a medium molecular weight material, and a low molecular weight material may be employed. The medium molecular weight material means a low polymer where the number of recurring structural units (degree of polymerization) is about 2 to 20. There is no clear distinction between the hole injection layer and the hole transporting layer, and both of them inevitably have hole transporting characteristics (hole mobility). A layer in contact with the anode is called a hole injection layer, and a layer in contact with the hole injection layer is distinguished as a hole transporting layer for convenience. The same applies to the electron transporting layer and the electron injection layer. A layer in contact with the cathode is called an electron injection layer while a layer in contact with the electron injection layer is called an electron transporting layer. The light emitting layer may combine the function of the electron transporting layer in some cases, and it is therefore called a light emitting electron transporting layer.

In the case of the pixel shown in FIG. 10A, light emitted from the light emitting element 6003 can be extracted from the first electrode 6004 side as shown by an outline arrow.

FIG. 10B is a cross sectional view of a pixel where a TFT 6011 has P-type conductivity, and light emitted from a light emitting element 6013 is extracted from a second electrode 6016 side. In FIG. 10B, a first electrode 6014 of the light emitting element 6013 is electrically connected to the TFT 6011, and an electroluminescent layer 6015 and the second electrode 6016 are stacked in this order over the first electrode 6014.

The first electrode 6014 is formed using a material that reflects or blocks light or formed to have a thickness to reflect or block light. In either case, a material suitable for the anode is used. For example, the first electrode 6014 may be formed of a single layer film containing one or more of TiN, ZrN, Ti, W, Ni, Pt, Cr, Ag, Al and the like, a stacked layer film of a titanium nitride film and a film mainly containing aluminum, a three-layer film of a titanium nitride film, a film mainly containing aluminum, and a titanium nitride film, or the like.

The second electrode 6016 is formed using a material that transmits light or formed to have a thickness to transmit light. In either case, a metal, an alloy, a conductive compound, and a mixture thereof, each of which has a low work function may be used. Specifically, it is possible to use an alkaline metal such as Li and Cs, an alkaline earth metal such as Mg, Ca and Sr, an alloy (Mg:Ag, Al:Li, Mg:In) or a compound (calcium fluoride such as CaF₂, calcium nitride such as Ca₃N₂) containing them, and a rare earth metal such as Yb and Er. If an electron injection layer is provided, other conductive layers such as Al may be employed as well. In addition, the second electrode 6016 is formed to have a thickness to transmit light (preferably about 5 to 30 nm). Note that the second electrode 6016 may be formed using conductive oxide materials that transmit light, such as indium tin oxide (ITO), zinc oxide (ZnO), indium zinc oxide (IZO), and gallium doped zinc oxide (GZO). Alternatively, ITO, zinc oxide containing silicon oxide, indium tin oxide containing silicon oxide (hereinafter referred to as ITSO), or ITSO mixed with zinc oxide (ZnO) of 2 to 20 atomic % may be used for the second electrode 6016. In the case of using the conductive oxide material that transmits light, an electron injection layer is desirably provided in the electroluminescent layer 6015.

The electroluminescent layer 6015 may be formed in the same manner as the electroluminescent layer 6005 shown in FIG. 10A.

In the case of the pixel shown in FIG. 10B, light emitted from the light emitting element 6013 can be extracted from the second electrode 6016 side as shown by an outline arrow.

FIG. 10C is a cross sectional view of a pixel where a TFT 6021 has P-type conductivity, and light emitted from a light emitting element 6023 is extracted from a first electrode 6024 side and a second electrode 6026 side. In FIG. 10C, the first electrode 6024 of the light emitting element 6023 is electrically connected to the TFT 6021, and an electroluminescent layer 6025 and the second electrode 6026 are stacked in this order over the first electrode 6024.

The first electrode 6024 may be formed in the same manner as the first electrode 6004 shown in FIG. 10A. The second electrode 6026 may be formed in the same manner as the second electrode 6016 shown in FIG. 10B. The electroluminescent layer 6025 may be formed in the same manner as the electroluminescent layer 6005 shown in FIG. 10A.

In the case of the pixel shown in FIG. 10C, light emitted from the light emitting element 6023 can be extracted from the first electrode 6024 side and the second electrode 6026 side as shown by outline arrows.

This embodiment mode can be implemented in combination with any of the aforementioned embodiment modes.

### Embodiment Mode 6

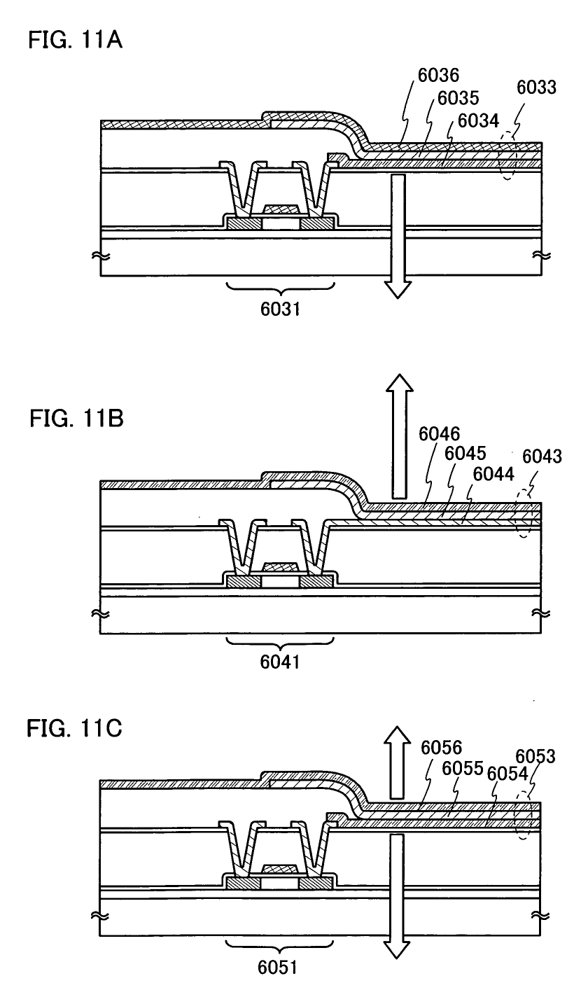

In this embodiment mode, cross sectional structures of a pixel where an N-channel TFT is used as a transistor for controlling current supply to a light emitting element are described with reference to FIGS. 11A to 11C. Note that in FIGS. 11A to 11C, the first electrode is the cathode while the second electrode is the anode, though the first electrode may be the anode while the second electrode may be the cathode.

FIG. 11A is a cross sectional view of a pixel where a TFT 6031 has N-type conductivity and light emitted from a light emitting element 6033 is extracted from a first electrode 6034 side. In FIG. 11A, the first electrode 6034 of the light emitting element 6033 is electrically connected to the TFT 6031, and an electroluminescent layer 6035 and a second electrode 6036 are stacked in this order over the first electrode 6034.

The first electrode 6034 is formed using a material that transmits light, or formed to have a thickness to transmit light. In either case, a metal, an alloy, a conductive compound, and a mixture thereof, each of which has a low work function may be used. Specifically, it is possible to use an alkaline metal such as Li and Cs, an alkaline earth metal such as Mg, Ca and Sr, an alloy (Mg:Ag, Al:Li, Mg:In) or a compound (calcium fluoride such as CaF₂, calcium nitride such as Ca₃N₂) containing them, and a rare earth metal such as Yb and Er. If an electron injection layer is provided, other conductive layers such as Al may be employed as well. In addition, the first electrode 6034 is formed to have a thickness to transmit light (preferably about to 30 nm). Further, a conductive layer that transmits light may be formed using a conductive oxide material that transmits light so as to be in contact with the top or the bottom of the aforementioned conductive layer having a thickness to transmit light, thereby the sheet resistance of the first electrode 6034 can be reduced. Note that it is also possible to use only the conductive layer using other conductive oxide materials that transmit light, such as indium tin oxide (ITO), zinc oxide (ZnO), indium zinc oxide (IZO), and gallium doped zinc oxide (GZO). Alternatively, ITO, zinc oxide containing silicon oxide, indium tin oxide containing silicon oxide (hereinafter referred to as ITSO), or ITSO mixed with zinc oxide (ZnO) of 2 to 20 atomic % may be used for the first electrode 6034. In the case of using the conductive oxide material that transmits light, an electron injection layer is desirably provided in the electroluminescent layer 6035.

The second electrode 6036 is formed using a material that reflects or blocks light, or formed to have a thickness to reflect or block light. In either case, a material suitable for the anode is used. For example, the second electrode 6036 may be formed of a single layer film containing one or more of TiN, ZrN, Ti, W, Ni, Pt, Cr, Ag, Al and the like, a stacked layer film of a titanium nitride film and a film mainly containing aluminum, a three-layer film of a titanium nitride film, a film mainly containing aluminum, and a titanium nitride film, or the like.

The electroluminescent layer 6035 may be formed in the same manner as the electroluminescent layer 6005 shown in FIG. 11A. If the electroluminescent layer 6035 includes any of a hole injection layer, a hole transporting layer, an electron transporting layer, and an electron injection layer as well as a light emitting layer, the electron injection layer, the electron transporting layer, the light emitting layer, the hole transporting layer, and the hole injection layer are stacked in this order from the first electrode 6034.

In the case of the pixel shown in FIG. 11A, light emitted from the light emitting element 6033 can be extracted from the first electrode 6034 side as shown by an outline arrow.

FIG. 11B is a cross sectional view of a pixel where a TFT 6041 has N-type conductivity, and light emitted from a light emitting element 6043 is extracted from a second electrode 6046 side. In FIG. 11B, a first electrode 6044 of the light emitting element 6043 is electrically connected to the TFT 6041, and an electroluminescent layer 6045 and the second electrode 6046 are stacked in this order over the first electrode 6044.

The first electrode 6044 is formed using a material that reflects or blocks light, or formed to have a thickness to reflect or block light. In either case, a metal, an alloy, a conductive compound, and a mixture thereof, each of which has a low work function may be used. Specifically, it is possible to use an alkaline metal such as Li and Cs, an alkaline earth metal such as Mg, Ca and Sr, an alloy (Mg:Ag, Al:Li, Mg:In) or a compound (calcium fluoride such as CaF₂, calcium nitride such as Ca₃N₂) containing them, and a rare earth metal such as Yb and Er. If an electron injection layer is provided, other conductive layers such as Al may be employed as well.

The second electrode 6046 is formed using a material that transmits light, or formed to have a thickness to transmit light. In either case, a material suitable for the anode is used. For example, the second electrode 6046 may be formed using conductive oxide materials that transmit light, such as indium tin oxide (ITO), zinc oxide (ZnO), indium zinc oxide (IZO), and gallium doped zinc oxide (GZO). Alternatively, ITO, zinc oxide containing silicon oxide, indium tin oxide containing silicon oxide (ITSO), or ITSO mixed with zinc oxide (ZnO) of 2 to 20 atomic % may be used for the second electrode 6046. Further, instead of using the aforementioned conductive oxide materials that transmit light, the second electrode 6046 may be formed of a single layer film containing one or more of TiN, ZrN, Ti, W, Ni, Pt, Cr, Ag, Al and the like, a stacked layer film of a titanium nitride film and a film mainly containing aluminum, or a three-layer film of a titanium nitride film, a film mainly containing aluminum, and a titanium nitride film. In the case of using a material other than the conductive oxide materials that transmit light, the second electrode 6046 is formed to have a thickness to transmit light (preferably about 5 to 30 nm).

The electroluminescent layer 6045 may be formed in the same manner as the electroluminescent layer 6035 shown in FIG. 11A.

In the case of the pixel shown in FIG. 11B, light emitted from the light emitting element 6043 can be extracted from the second electrode 6046 side as shown by an outline arrow.

FIG. 11C is a cross sectional view of a pixel where a TFT 6051 has N-type conductivity, and light emitted from a light emitting element 6053 is extracted from a first electrode 6054 side and a second electrode 6056 side. In FIG. 11C, the first electrode 6054 of the light emitting element 6053 is electrically connected to the TFT 6051, and an electroluminescent layer 6055 and the second electrode 6056 are stacked in this order over the first electrode 6054.

The first electrode 6054 may be formed in the same manner as the first electrode 6034 shown in FIG. 11A. The second electrode 6056 may be formed in the same manner as the second electrode 6046 shown in FIG. 11B. The electroluminescent layer 6055 may be formed in the same manner as the electroluminescent layer 6035 shown in FIG. 11A.

In the case of the pixel shown in FIG. 11C, light emitted from the light emitting element 6053 can be extracted from the first electrode 6054 side and the second electrode 6056 side as shown by outline arrows.

This embodiment mode can be implemented in combination with any of the aforementioned embodiment modes.

### Embodiment Mode 7

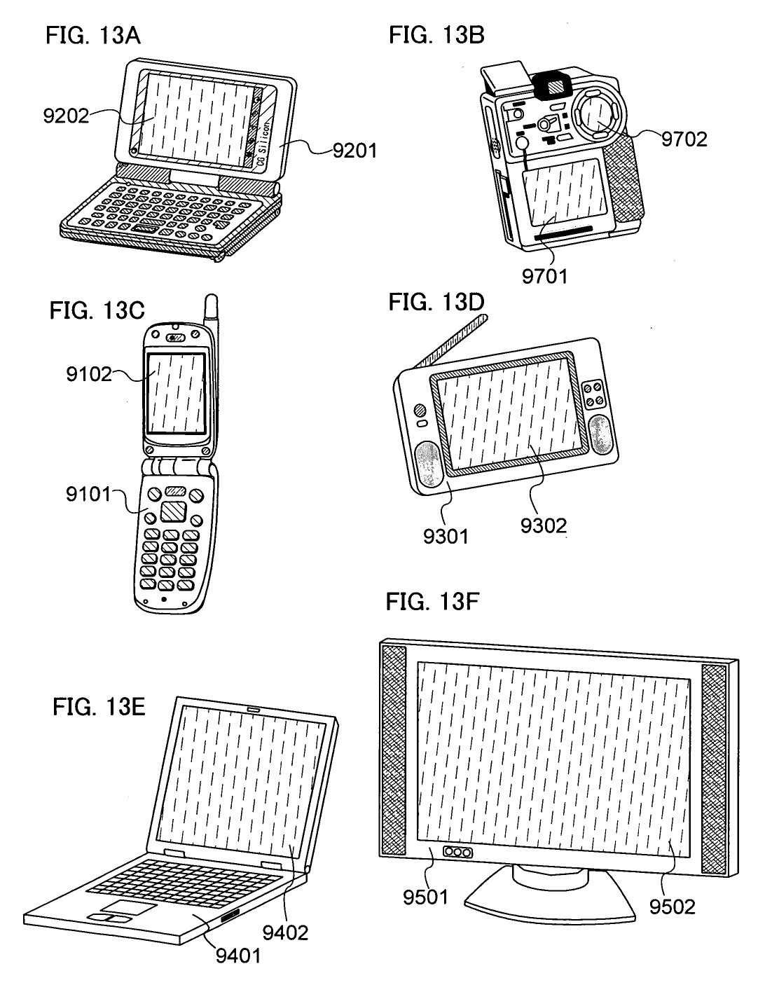

An electronic apparatus provided with the active display device of the invention includes a television set (also called a television or a television receiver), a digital camera, a digital video camera, a mobile phone set (also called a mobile phone or a cellular phone), a portable information terminal such as a PDA, a portable game machine, a monitor for a computer, a computer, an audio reproducing device such as a car audio system, an image reproducing device provided with a recording medium such as a home game machine, and the like. Specific examples of them are described with reference to FIGS. 13A to 13F.

FIG. 13A shows a portable information terminal having a main body 9201, a display portion 9202 and the like. The active display device of the invention can be applied to the display portion 9202. As a result, the portable information terminal where the occurrence of a pseudo contour is reduced can be provided.

FIG. 13B shows a digital video camera having a display portion 9701, a display portion 9702 and the like. The active display device of the invention can be applied to the display portion 9701. As a result, the digital video camera where the occurrence of a pseudo contour is reduced can be provided.

FIG. 13C shows a mobile phone set having a main body 9101, a display portion 9102 and the like. The active display device of the invention can be applied to the display portion 9102. As a result, the mobile phone set where the occurrence of a pseudo contour is reduced can be provided.

FIG. 13D shows a portable television set having a main body 9301, a display portion 9302 and the like. The active display device of the invention can be applied to the display portion 9302. As a result, the portable television set where the occurrence of a pseudo contour is reduced can be provided. The active display device of the invention can be widely applied to a small size television set incorporated in a portable terminal such as a mobile phone, a medium size one that is portable, and a large size one (e.g., 40 inches in size or more).

FIG. 13E shows a portable computer having a main body 9401, a display portion 9402 and the like. The active display device of the invention can be applied to the display portion 9402. As a result, the portable computer where the occurrence of a pseudo contour is reduced can be provided.

FIG. 13F shows a television set having a main body 9501, a display portion 9502 and the like. The active display device of the invention can be applied to the display portion 9502. As a result, the television set where the occurrence of a pseudo contour is reduced can be provided.

As set forth above, the active display device of the invention allows the electronic apparatuses where the occurrence of a pseudo contour is reduced to be provided.

This application is based on Japanese Patent Application serial No. 2004-280075 filed in Japan Patent Office on Sep. 27, 2004, the entire contents of which are hereby incorporated by reference.

What is claimed is:

1. A driving method of an active display device comprising a plurality of pixels arranged in matrix wherein a video signal is inputted to the plurality of pixels during each of a plurality of frame periods, comprising the steps of:
displaying an image on a pixel belonging to an odd-numbered row and an odd-numbered column and a pixel belonging to an even-numbered row and an even-numbered column during an odd-numbered frame period of the plurality of frame periods; and
displaying an image on a pixel belonging to an odd-numbered row and an even-numbered column and a pixel belonging to an even-numbered row and an odd-numbered column during an even-numbered frame period of the plurality of frame periods.

2. A driving method of an active display device comprising a plurality of pixels arranged in matrix wherein a video signal is inputted to the plurality of pixels during each of a plurality of frame periods, comprising the steps of:
displaying an image on a pixel belonging to an odd-numbered row and an odd-numbered column and a pixel belonging to an even-numbered row and an even-numbered column during an odd-numbered frame period of the plurality of frame periods, and inputting a video signal to a pixel of the odd-numbered column when an inversion signal inputted to the pixel is High; and
displaying an image on a pixel belonging to an odd-numbered row and an even-numbered column and a pixel belonging to an even-numbered row and an odd-numbered column during an even-numbered frame period of the plurality of frame periods, and inputting a video signal to a pixel of the even-numbered column when an inversion signal inputted to the pixel is High.

3. The driving method of an active display device, according to claim 1, wherein when the inversion signal inputted to the pixels is High during the odd-numbered frame period, the inversion signal inputted to the pixels is Low during the even-numbered frame period.

4. An active display device comprising:
a plurality of pixels at intersections of a plurality of signal lines and a plurality of scan lines;
a semiconductor element connected to each of the plurality of signal lines;
a circuit for controlling the semiconductor element comprising:
a shift register comprising shift register units; and
a latch circuit comprising latch units and a wiring inputted with an inversion signal for controlling a selection of the latch units,
wherein adjacent latch units are connected between adjacent shift register units; and
wherein one of the adjacent latch units is selected by a signal from the shift register units and the inversion signal.

5. An active display device comprising:
a plurality of pixels at intersections of a plurality of signal lines and a plurality of scan lines;
a semiconductor element connected to each of the plurality of signal lines;
a circuit for controlling the semiconductor element comprising:
a shift register comprising shift register units; and
a latch circuit comprising latch units, a wiring inputted with an inversion signal for controlling a selection of the latch units, and a switching element switched by the inversion signal,
wherein adjacent latch units are connected between adjacent shift register units; and
wherein one of the adjacent latch units are selected by the switching element.

6. An active display device comprising:
a plurality of pixels at intersections of a plurality of signal lines and a plurality of scan lines;
a semiconductor element connected to each of the plurality of scan lines
a circuit for controlling the semiconductor element comprising:
a wiring inputted with a selection signal;
a shift register;
a level shifter; and
an AND circuit inputted with a signal from the shift register and the selection signal, and connected so as to output a signal to the level shifter.

7. An active display device comprising:
a plurality of pixels at intersections of a plurality of signal lines and a plurality of scan lines;
a semiconductor element connected to each of the plurality of scan lines
a circuit for controlling the semiconductor element comprising:
a wiring inputted with a selection signal,
a shift register, and a level shifter; and
an AND circuit inputted with a signal from the shift register and the selection signal, and connected so as to output a signal to the level shifter,
wherein the plurality of signal lines and the plurality of pixels are connected so that a video signal is inputted to a pixel selected by the circuit for controlling the semiconductor element.

8. An active display device comprising:
a plurality of pixels at intersections of a plurality of signal lines and a plurality of scan lines;
a semiconductor element connected to each of the plurality of signal lines;
a circuit for controlling the semiconductor element comprising:
a shift register comprising shift register units; and
a latch circuit latch units and a wiring inputted with an inversion signal for controlling a selection of the latch units,
wherein the latch units are connected between adjacent shift register units.

9. An active display device comprising:
a plurality of pixels at intersection of a plurality of signal lines and a plurality of scan lines;
a semiconductor element connected to each of the plurality of signal lines
a circuit for controlling the semiconductor element comprising:
a shift register comprising shift register units; and
a latch circuit comprising latch units, a wiring inputted with an inversion signal for controlling a selection of the latch units, and a switching element switched by the inversion signal;
wherein the latch units are connected between adjacent shift register units.

10. The active display device according to claim 5, wherein a semiconductor element having a first conductivity and a semiconductor element having a second conductivity are used as the switching element.

11. The active display device according to claim 9, Wherein a semiconductor element having a first conductivity and a semiconductor element having a second conductivity are used as the switching element.
